(19) United States
(12) Patent Application Publication
(10) Pub. No.: US 2024/0352210 A1
(43) Pub. Date: Oct. 24, 2024

(54) FOAM STABILIZERS FOR PHENOLIC FOAM

(71) Applicant: Evonik Operations GmbH, Essen (DE)

(72) Inventors: Michael SUCHAN, Gelsenkirchen (DE); Sarah OTTO, Essen (DE); Michael FERENZ, Essen (DE)

(21) Appl. No.: 18/641,381

(22) Filed: Apr. 21, 2024

(30) Foreign Application Priority Data
Apr. 24, 2023 (EP) 23169356.5

(51) Int. Cl. C08J 9/00

(52) U.S. Cl. CPC C08J 9/0061; C08J 2361/06; C08J 2433/14

(57) ABSTRACT

The invention relates to a composition for producing phenolic foam, comprising at least one phenolic resin, at least one blowing agent, at least one catalyst, characterized in that it comprises at least one acrylate and/or methacrylate copolymer as foam stabilizer.

### CROSS REFERENCE TO RELATED APPLICATIONS

The present application claims priority under 35 USC § 119 to European application EP 23169356.5, filed on Apr. 24, 2023, the content of which is incorporated herein by reference in its entirety.

### FIELD OF THE INVENTION

The present invention is in the field of phenolic foams. In particular, it relates to a composition for producing phenolic foam, to a process for producing phenolic foam, to phenolic foam produced according to the invention and to the use thereof.

### BACKGROUND OF THE INVENTION

Phenolic foam is in the context of the present invention understood as meaning in particular a foam obtainable by reacting a phenolic resin with an acid as catalyst alongside addition of a blowing agent and a foam stabilizer. Phenolic foams are known to those skilled in the art and described for example in EP 3830174 A1, DE 602004006376 T2, EP 2898005 A1, EP 1922357 A1, WO 2022043561 A1, EP 4073155 A1, AU 2021238847 A1 or WO 2006114777 A1. Phenolic foams are also referred to synonymously as phenolic resin foams. This is also applicable to the present invention.

In phenolic foam production, it is customary to employ cell-stabilizing or foam-stabilizing additives that ensure a fine-celled, homogeneous foam structure with a low level of defects and hence exert an essentially positive influence on the performance characteristics, for example the thermal insulation performance in particular, of the foam. It is usually possible to use for this purpose foam stabilizers, for example foam stabilizers based on ethoxylated vegetable oils such as castor oil, as described for example in EP 3830174 A1. The use of polyether-modified siloxanes (PES), as described for example in WO 2022043561 A1, has been found to be particularly effective at improving performance characteristics further. The combination of ethoxylated vegetable oils and polyether-modified siloxanes in particular results in excellent performance characteristics. This combination therefore represents a type of foam stabilizer that is usually preferred in the production of phenolic foam.

The use of polyether-modified siloxanes as foam stabilizers in the presence of acids as catalyst can lead to degradation of the polyether-modified siloxanes and resultant formation of cyclic siloxanes, especially octamethylcyclotetrasiloxane (D4), decamethylcyclopentasiloxane (D5) and dodecamethylcyclohexasiloxane (D6), which have an adverse effect on the properties, especially the emissions, of the phenolic foam.

### BRIEF DESCRIPTION OF THE INVENTION

Against this background, it was an object of the present invention to provide phenolic foams having similar performance characteristics, especially thermal insulation properties, to those of phenolic foams produced with conventional polyether-modified siloxanes, but, with regard to emissions associated with the formation of cyclic siloxanes, having zero or lower formation of D4, D5 and/or D6.

The object is achieved by the subject matter of the invention. The invention provides a composition for producing phenolic foam, comprising at least one phenolic resin, at least one blowing agent, at least one catalyst, wherein the composition comprises at least one acrylate and/or methacrylate copolymer as foam stabilizer.

### DETAILED DESCRIPTION OF THE INVENTION

The subject matter of the invention is associated with a variety of advantages. For instance, it enables the provision of phenolic foams that satisfy the known demands. In particular, the phenolic foams have very good insulation properties and exhibit excellent long-term characteristics and high surface quality. Advantageously, this is enabled without impairing the other properties of the material and without, or with only lower, formation of cyclic siloxanes, especially D4, D5 and/or D6. Moreover, particularly fine-celled, homogeneous foam structures with a low level of defects are enabled. The invention in principle enables siloxane-free foam stabilization, i.e. it makes it possible to dispense completely with siloxane-based additives, for example the known polyether-modified siloxanes.

Moreover, it permits joint use together with the alkoxylated vegetable oils known from the prior art.

In a particularly preferred embodiment of the invention, it is a feature of the composition according to the invention that the at least one acrylate and/or methacrylate copolymer contains at least one comonomer of the H₂C═CR¹—COOR² type and at least one comonomer of the H₂C═CR¹—COOR³ type, where
R¹=each independently —H or —CH₃, where different comonomers having different R¹ substituents may be present within one copolymer,
R²=each independently identical or different radicals from the group of saturated or unsaturated, linear, cyclic or branched, aliphatic or aromatic hydrocarbons having 1 to 25 carbon atoms, preferably methyl, ethyl, n-butyl, isobutyl, t-butyl, 2-ethylhexyl, isodecyl, cyclohexyl, benzyl, phenyl, isobornyl or allyl,
R³=each independently identical or different polyether radicals of the general average composition according to formula (1):

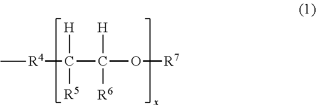

where:
x=1 to 500, preferably 1 to 250, especially 3 to 80,
R⁴=each independently identical or different —CH₂—O—, —CH₂—CH₂—O—, —CH₂—CH₂—CH₂—O—, —CH₂—CH₂—CH₂—CH₂—O— or —CH₂—CH₂—CH₂—CH₂—CH₂—O— radicals, where R⁴ may also be absent,
R⁵=each independently identical or different alkyl radicals having 1 to 18 carbon atoms and optionally having ether functions, or identical or different aryl radicals having 6 to 18 carbon atoms and optionally having ether functions, or H, preferably H, methyl, ethyl or benzyl, where different R⁵ substituents within an R³ radical may be present in any order or sequence,
R⁶=each independently identical or different alkyl radicals having 1 to 18 carbon atoms and optionally having ether functions, or identical or different aryl radicals having 6 to 18 carbon atoms and optionally having ether functions, or H, preferably H, methyl, ethyl or benzyl, where different R⁶ substituents within an R³ radical may be present in any order or sequence, where, for one repeat monomer unit, preferably both R⁵ and R⁶ radicals=H or one of the two R⁵ and R⁶ radicals=H and the other is methyl,
R⁷=each independently identical or different radicals selected from the group consisting of: R⁸, C(O)R⁸, —CH₂—CH(OH)—CH₂OH and —CH₂—C(CH₂OH)₂—CH₂—CH₃, preference being given to methyl, butyl, H or C(O)Me, where, within a copolymer, different comonomers may be present with different R⁷ substituents,
R⁸=each independently identical or different alkyl radicals having 1 to 16 carbon atoms, identical or different aryl radicals having 6 to 16 carbon atoms or H.

Particularly preferred examples of acrylate and/or methacrylate monomers usable in the context of the invention are, but are not limited to, methyl (meth)acrylate, ethyl (meth)acrylate, propyl (meth)acrylate, isopropyl (meth)acrylate, butyl (meth)acrylate, isobutyl (meth)acrylate, hexyl (meth)acrylate, ethylhexyl (meth)acrylate, isodecyl (meth)acrylate, cyclohexyl (meth)acrylate, tetrahydrofurfuryl (meth)acrylate, isobornyl (meth)acrylate, benzyl (meth)acrylate, phenyl (meth)acrylate, phenylethyl (meth)acrylate, 3,3,5-trimethylcyclohexyl (meth)acrylate, hydroxyalkyl (meth)acrylates, for example 3-hydroxypropyl methacrylate, 3,4-dihydroxybutyl methacrylate, 2-hydroxyethyl methacrylate, 2-hydroxypropyl methacrylate, 2,5-dimethylhexane-1,6-diol(meth)acrylate, decane-1,10-diol (meth)acrylate; glycol dimethacrylates, for example butane-1,4-diol methacrylate, 2-butoxyethyl methacrylate, 2-ethoxyethoxymethyl methacrylate, 2-ethoxyethyl methacrylate; methacrylates of ether alcohols, for example tetrahydrofurfuryl methacrylate, vinyloxyethoxyethyl methacrylate, methoxyethoxyethyl methacrylate, 1-butoxypropyl methacrylate, 1-methyl-(2-vinyloxy)ethyl methacrylate, cyclohexyloxymethyl methacrylate, methoxymethoxyethyl methacrylate, benzyloxymethyl methacrylate, furfuryl methacrylate, 2-butoxyethyl methacrylate, 2-ethoxyethoxymethyl methacrylate, 2-ethoxyethyl methacrylate, allyloxymethyl methacrylate, 1-ethoxybutyl methacrylate, methoxymethyl methacrylate, 1-ethoxyethyl methacrylate, ethoxymethyl methacrylate and/or ethoxylated or propoxylated (meth)acrylates having preferably 1 to 20, especially 2 to 8 ethoxy groups or propoxy groups.

The notation “(meth)acrylate” here means both methacrylate, for example methyl methacrylate, ethyl methacrylate, etc., and acrylate, for example methyl acrylate, ethyl acrylate, etc., and mixtures of the two.

Moreover, processes for preparing usable acrylate and/or methacrylate copolymers are known from the prior art to those skilled in the art. These are described, for example, in EP 1070730 A2 or U.S. Pat. No. 9,349,500 B2.

In a further particularly preferred embodiment of the invention, it is a feature of the composition according to the invention that the at least one blowing agent is selected from the group consisting of
hydrocarbons having 3, 4 or 5 carbon atoms, preferably cyclo-, iso- and/or n-pentane, and
halogenated hydrocarbons having 3, 4 or 5 carbon atoms, preferably isopropyl chloride, hydrofluoroolefins and/or hydrohaloolefins, preferably 1234ze, 1234yf, 1224yd, 1233zd(E) and/or 1336mzz.

If the at least one acrylate and/or methacrylate copolymer has a number-average molecular weight Mn, determined by gel permeation chromatography in accordance with DIN 55672-1:2016-03 (eluent: THF; standard: PMMA), in the range from 500 to 100 000 g/mol, more preferably 1000 to 40 000 g/mol, especially 1000 to 25 000 g/mol, this is again a further particularly preferred embodiment of the invention.

In a further particularly preferred embodiment of the invention, the at least one acrylate and methacrylate copolymer is present in the composition according to the invention in a total amount of 0.1 to 15 parts by weight, preferably 0.5 to 10 parts by weight, more preferably 0.5 to 8 parts by weight, based on 100 parts by weight of the total phenolic resin used.

The composition according to the invention may preferably additionally contain at least one Si-containing foam stabilizer, preferably in a total amount of less than 50% by weight, further preferably less than 25% by weight, even further preferably less than 10% by weight, based on the total amount of all foam stabilizers present.

In a further preferred embodiment of the invention, the composition according to the invention does not contain any Si-containing foam stabilizer.

In a further preferred embodiment of the invention, the composition according to the invention additionally includes at least one silicon-free surfactant and/or silicon-free foam stabilizer, neither of which is an acrylate and/or methacrylate copolymer, in a total amount of 0.1 to 15 parts by weight, preferably 1 to 10 parts by weight, based on 100 parts by weight of the total phenolic resin used.

If a composition according to the invention additionally includes at least one alkoxylated, preferably ethoxylated, vegetable oil, especially castor oil, in a total amount of 0.1 to 15 parts by weight, preferably 1 to 10 parts by weight, based on 100 parts by weight of the total phenolic resin used, this corresponds to a further preferred embodiment of the invention.

Initiators used for preparation of acrylate and/or methacrylate copolymers usable in accordance with the invention may in principle be compounds that break down to free radicals under the polymerization conditions, for example peroxides, hydroperoxides, hydrogen peroxide, persulfates, azo compounds and what are called redox initiators. In some cases, it may also be advantageous to use mixtures of different initiators, for example mixtures of hydrogen peroxide and sodium or potassium peroxodisulfate. Possible organic peroxides are, for example, acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl peroxy-2-ethylhexanoate, tert-butyl perisononanoate, tert-butyl permaleate, tert-butyl perbenzoate, di-(2-ethylhexyl) peroxydicarbonate, dicyclohexyl peroxydicarbonate, di-(4-tert-butylcyclohexyl) peroxydicarbonate, dimyristil peroxydicarbonate, diacetyl peroxydicarbonate, allyl peresters, cumyl peroxyneodecanoate, tert-butyl per-3,5,5-trimethylhexanoate, acetyl cyclohexylsulfonyl peroxide, dilauryl peroxide and/or tert-amyl peroxy-2-ethylhexanoate. Further possible initiators are azo compounds, for example 2,2′-azobisisobutyronitrile, 2,2′-azobis(2,4-dimethylvaleronitrile) and/or 2,2′-azobis(4-methoxy-2,4-dimethylvaleronitrile).

It has been found that, surprisingly, in the context of the present invention, when acrylate and/or methacrylate copolymers usable in accordance with the invention are prepared preferably with tert-butyl peroxy-2-ethylhexanoate (TBPEH) or tert-amyl peroxy-2-ethylhexanoate (APO) or a combination of TBPEH and APO as initiator, even better results can then be achieved with regard to the target properties according to the invention. Therefore, in a particularly preferred embodiment of the invention, the at least one acrylate and/or methacrylate copolymer has been prepared using TBPEH (tert-butyl peroxy-2-ethylhexanoate) and/or APO (tert-amyl peroxy-2-ethylhexanoate) as initiator.

In addition, in a particularly preferred embodiment of the invention, the at least one acrylate and/or methacrylate copolymer has a residual monomer content of <1% by weight, based on the total acrylate and/or methacrylate copolymer present.

The residual monomer content can be determined by customary methods; in particular, it can be determined via the solids content or by GC or HPLC. Corresponding compositions enable foams that are particularly advantageous in accordance with the invention.

In addition to the at least one acrylate and/or methacrylate copolymer to be used according to the invention, it is possible in principle to use any of the foam-stabilizing components known from the prior art.

The composition according to the invention contains at least one catalyst. In a particularly preferred embodiment of the invention, the at least one catalyst is selected from the group consisting of organic and inorganic acids, the at least one catalyst preferably being selected from the group consisting of sulfuric acid, phosphoric acid, benzenesulfonic acid, xylenesulfonic acid, para-toluenesulfonic acid, ethylbenzenesulfonic acid, naphtholsulfonic acid, cumenesulfonic acid and phenolsulfonic acid.

In a further particularly preferred embodiment of the invention, the at least one catalyst is present in the composition according to the invention in a total amount of 1 to 30 parts by weight, preferably 1 to 25 parts by weight, more preferably 3 to 20 parts by weight, based on 100 parts by weight of the total phenolic resin used.

It is possible with preference to use the at least one acrylate and/or methacrylate copolymer used in accordance with the invention in neat form or else in a solvent. It is possible here to use all suitable substances that are usable in the production of phenolic foams.

A particularly preferred phenolic foam formulation for the purposes of the present invention gives a foam density of 5 to 900 kg/m³ and has preferably the composition shown in Table 1, which corresponds to a preferred embodiment of the invention:

TABLE 1
Composition of a preferred phenolic foam formulation

| Component | Parts by weight |
|---|---|
| Phenolic resin | 80 to 120 |
| Blowing agent | >0 to 50 |
| Catalyst | 1 to 30 |
| Foam stabilizer (inventive acrylate and/or | >0 to 15 |
| methacrylate copolymer) | |
| Optionally further additives (flame retardants, etc.) | 0 to 100 |

The present invention further provides a process for producing phenolic foam, using a reaction mixture comprising a composition according to the invention as described above, especially as defined in any of Claims 1 to 12.

For further preferred embodiments and configurations of the process according to the invention, reference is also made to the statements already given above in connection with the composition according to the invention.

The present invention further provides a phenolic foam produced by the aforementioned process according to the invention, preferably using a composition according to the invention, especially as defined in any of Claims 1 to 12.

A particularly preferred phenolic foam has a density to ASTM D1622-2020 of 5 to 500 kg/m³, preferably 10 to 200 kg/m³, especially preferably 12 to 100 kg/m³. This corresponds to a particularly preferred embodiment of the invention.

The invention further provides for the use of the phenolic foam according to the invention for thermal insulation.

There follows a more specific description of particularly preferred compositions according to the invention.

A particularly preferred composition of the invention comprises the following constituents:
at least one phenolic resin,
at least one blowing agent,
at least one catalyst,
at least one acrylate and/or methacrylate copolymer as foam stabilizer
optionally further additives, etc.

The production of phenolic foams (also referred to synonymously as phenolic resin foams; these terms are synonymous in the context of the invention) is known per se. For the production of phenolic foams, one or more phenolic resins are used, preferably one or more of the type called resol resins. Correspondingly usable phenolic resins, preferably resol resins, are known per se. In particular, they can be produced in a known manner by condensation of phenol or a phenol-based compound, for example cresol, xylenol, para-alkyl phenol, para-phenylphenol, resorcinol or the like, and an aldehyde, for example formaldehyde, furfural, acetaldehyde or the like, under preferably basic conditions, for example by using a catalytic amount of alkali metal hydroxides, for example sodium hydroxide, potassium hydroxide or calcium hydroxide or an aliphatic amine, for example trimethylamine or triethylamine, preferably with an excess of aldehyde. This represents the usual way of producing phenolic resins, preferably resol resins, although the invention is not limited solely to the chemicals listed immediately above.

The molar ratio of phenol groups to aldehyde groups is not subject to any restriction. Preferably, the ratio is within a range from 1:1 to 1:3, more preferably within a range from 1:1.5 to 1:2.5. Preferably, but without limitation, the phenolic resin has a free aldehyde content of 0.1% by weight to 0.5% by weight. This can be determined by potentiometric titration according to ISO 11402:2004 with hydroxylamine hydrochloride.

Preferred phenolic resins that can be used in foam production are liquids at 25° C. and standard pressure, preferably have water concentrations of from about 1% to 25% by weight, preferably 5% to 20% by weight, and have methylol groups as reactive substituents, as described for example in EP 0170357 B1. If desired, the viscosity of the phenolic resin can be through, inter alia, the water content. Thus, high water contents usually result in lower viscosity, which facilitates both the handling of the resin and its mixing during foam production.

The viscosity of preferred phenolic resins at 25° C. and standard pressure is preferably within a range from 1000 to 28 000 mPa*s and can be determined by the usual methods known to those skilled in the art, for example using a Brookfield viscometer. The fundamentals on the production and composition of phenolic resins can be found in the prior art and in particular are described for example in EP 3830174 A1, EP 2898005 A1, WO 2022043561 A1 or EP 4073155 A1.

Blowing agents and the use thereof in the production of phenolic foams are known to those skilled in the art. The use of one or more blowing agents depends in principle on the nature of the system and on the use for the phenolic foam obtained. Depending on the amount of blowing agent used, a foam having high or low density can be produced. For instance, it is possible to produce according to ASTM D1622-20 foams having densities of preferably 5 kg/m³ to 900 kg/m³, preferably 5 to 500 kg/m³, more preferably 10 to 200 kg/m³, especially 12 to 100 kg/m³.

The blowing agent used may preferably be one or more of the appropriate compounds having suitable boiling points, for example hydrocarbons having 3, 4 or 5 carbon atoms, preferably cyclo-, iso- or n-pentane, halogenated hydrocarbons, for example chlorinated hydrocarbons such as dichloroethane, 1,2-dichloroethene, n-propyl chloride, isopropyl chloride, butyl chloride, isobutyl chloride, pentyl chloride, isopentyl chloride, 1,1-dichloroethene, trichloroethene or chloroethene, or hydrofluorocarbons (HFCs), for example HFC 245fa, HFC 134a or HFC 365mfc, hydrofluoroolefins (HFOs) or hydrohaloolefins, preferably 1234ze, 1234yf, 1224yd, 1233zd(E) or 1336mzz or mixtures thereof.

Catalysts that can be used for the production of phenolic foams are known from the prior art to those skilled in the art and described for example in EP 0170 357 A1 or in DE 602004006376 T2. The customary organic and inorganic acids known from the prior art can be employed with preference for this purpose. It is possible to use one or more than one acid. The following are usable with particular preference: sulfuric acid, phosphoric acid, benzenesulfonic acid, xylenesulfonic acid, para-toluenesulfonic acid, ethylbenzenesulfonic acid, naphthalenesulfonic acid, cumenesulfonic acid and/or phenolsulfonic acid. In particular, catalysts used may be mixtures of a plurality of these compounds. The preferred amount of catalysts employed for a complete reaction is influenced inter alia by the water content of the phenolic resin and/or—when the catalyst is present as an aqueous solution—also by the water content thereof. For example, a higher water content may necessitate a higher acid concentration.

Phenolic foam can be formed in a known manner, i.e. especially through reaction of a mixture comprising phenolic resin, blowing agent, foam stabilizer and catalyst. When a catalyst is added to a mixture of phenolic resin, blowing agent and foam stabilizer, an exothermic reaction occurs between the methylol groups and phenol, resulting in the formation of methylene bridges and crosslinking. The condensation is accompanied by the liberation of water. The exothermicity of the reaction and foam formation are influenced by the nature and amount of the acid used, the properties of the blowing agent and the structure of the foam stabilizer.

Foam stabilizers and the use thereof in the production of phenolic foams are well known to those skilled in the art, as described above. According to the invention, at least one foam stabilizer based on an acrylate and/or methacrylate copolymer is used. In addition, it is also possible to use additional foam stabilizers that assist foam production. These compounds are sufficiently well known from the prior art. For example, EP 3830174 A1 describes the use of ethoxylated castor oil.

Optional additives used may be one or more of the substances known from the prior art that are commonly used in the production of phenolic foams, for example viscosity reducers, plasticizers, hardeners, flame retardants, cell-refining additives, fillers, dyes, pigments and/or fragrances. Suitable optional additives are described for example in EP 3830174 A1, U.S. Pat. No. 4,444,912 A and EP 1922357 A1.

Optional solid fillers used may, for example, be metal hydroxides, such as aluminium hydroxide, magnesium hydroxide, metal carbonates, such as calcium carbonate, magnesium carbonate, barium carbonate or zinc carbonate, metal oxides, such as aluminium oxide or zinc oxide, or metal powders, such as zinc. The viscosity of the phenolic resin can optionally be reduced using monoethylene glycol or polyester polyols, for example. Hardeners optionally used may, for example, be compounds having amino groups, such as urea or dicyandiamide. Preference is given to using urea. These can optionally be used for foaming as well as for the production of the phenolic resin.

The process according to the invention for producing phenolic foams can be performed by any of the known methods. These are known to those skilled in the art and are described for example in EP 3830174 A1.

Unless the opposite is apparent from this description, it is possible to combine any preferred or particularly preferred embodiment of the invention with one or more of the other preferred or particularly preferred embodiments of the invention.

The subject matter of the invention is described below by way of example, without any intention of restricting the invention, the scope of application of which is apparent from the entirety of the description and the claims, to these exemplary embodiments. Where ranges, general formulas or classes of compounds are stated, these are intended to encompass not just the corresponding ranges or groups of compounds explicitly mentioned but also all subranges and subgroups of compounds that can be obtained by removing individual values (ranges) or compounds. Where documents are cited in the context of the present description, the entire content thereof, particularly with regard to the subject matter that forms the context in which the document has been cited, is intended to form an integral part of the disclosure content of the present invention. Unless stated otherwise, percentages are in percent by weight. Where average values are reported, these are numerical averages unless stated otherwise. Where parameters that have been determined by measurement are reported, the measurements have been carried out at a temperature of 23° C. and standard pressure, unless stated otherwise.

### Examples

### Example 1: Synthesis of Copolymers A to J

### Copolymer A:

An initial charge of 30.01 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.2 g of TBPEH (tert-butyl peroxy-2-ethylhexanoate), 56.18 g of isobutyl methacrylate (i-BMA), 67.29 g of MPEG500 methacrylate (MPEG500MA) and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1:2016-03 (eluent: THF; standard: PMMA): Mw=5630 g/mol; Mn=2560 g/mol; PDI (polydispersity)=2.2.

### Copolymer B:

An initial charge of 30.09 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.18 g of TBPEH (tert-butyl peroxy-2-ethylhexanoate), 76.75 g of isobutyl methacrylate (i-BMA), 46.58 g of MPEG500 methacrylate (MPEG500MA) and 2.21 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1:2016-03 (eluent: THF; standard: PS): Mw=7373 g/mol; Mn=3156 g/mol; PDI=2.3.

### Copolymer C:

An initial charge of 30.15 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.02 g of TBPEH (tert-butyl peroxy-2-ethylhexanoate), 53.77 g of isobutyl methacrylate (i-BMA), 70.92 g of MPEG500 methacrylate (MPEG500MA) and 1.15 g of 2-mercaptoethanol was metered in over a period of 4 h using a peristaltic pump. The mixture was stirred at this temperature for a further 30 min. The mixture was cooled to 80° C., 0.12 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1:2016-03 (eluent: THF; standard: PS): Mw=11 290 g/mol; Mn=3536 g/mol; PDI=3.2.

### Copolymer D:

An initial charge of 30.01 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.2 g of TBPEH, 54.69 g of isodecyl methacrylate (IDMA), 68.77 g of MPEG500MA and 2.21 g of 2-mercaptoethanol was metered in over a 4 h period using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1:2016-03 (eluent: THF; standard: PMMA): Mw=5250 g/mol; Mn=2410 g/mol; PDI=2.2.

### Copolymer E:

An initial charge of 30.08 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.23 g of TBPEH (tert-butyl peroxy-2-ethylhexanoate), 76.93 g of isobutyl methacrylate (i-BMA), 46.54 g of MPEG500 methacrylate (MPEG500MA) and 2.25 g of 2-mercaptoethanol was metered in over a period of 4 h using a peristaltic pump. The mixture was stirred at this temperature for a further 30 min. The mixture was cooled to 80° C., 0.14 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1:2016-03 (eluent: THF; standard: PS): Mw=6202 g/mol; Mn=2427 g/mol; PDI=2.6.

### Copolymer F:

An initial charge of 29.85 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 9.12 g of TBPEH (tert-butyl peroxy-2-ethylhexanoate), 52.38 g of isobutyl methacrylate (i-BMA), 68.67 g of MPEG500 methacrylate (MPEG500MA) and 4.45 g of 2-mercaptoethanol was metered in over a period of 4 h using a peristaltic pump. The mixture was stirred at this temperature for a further 30 min. The mixture was cooled to 80° C., 0.13 g of TBPEH dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1:2016-03 (eluent: THF; standard: PS): Mw=5103 g/mol; Mn=2127 g/mol; PDI=2.4.

### Copolymer G:

An initial charge of 30.01 g of n-butyl acetate in a 500 ml four-neck flask equipped with reflux condenser and N₂ line, sabre stirrer (200 rpm) and Pt100 digital internal thermometer was heated to 145° C. with an oil bath. A mixture of 20.75 g of BP-50-FT (dibenzoyl peroxide), 50.92 g of iBMA, 60.99 g of MPEG500MA and 2.21 g of 2-mercaptoethanol was metered in over a period of 4 h using a peristaltic pump. The mixture was stirred at this temperature for a further 30 min. The mixture was cooled to 80° C., 0.13 g of BP-50-FT dissolved in 10 g of n-butyl acetate was metered in for further reaction, and the mixture was stirred at 80° C. for a further 2 h. A further 5 g of n-butyl acetate was added and the mixture was stirred for a further 30 min without heating.

GPC to DIN 55672-1:2016-03 (eluent: THF; standard: PMMA): Mw=6350 g/mol; Mn=4080 g/mol; PDI=1.6.

### Copolymer H:

An initial charge of a mixture of 265.05 g of petroleum benzine (bp 100-120° C.) and 265.05 g of toluene in a 1000 ml four-neck flask equipped with reflux condenser and N₂ line, sabre stirrer (100 rpm) and Pt100 digital internal thermometer was heated to 135° C. with an oil bath. A mixture of 4.43 g of BP-50-FT (dibenzoyl peroxide), 90.59 g of C17,4MA (stearyl methacrylate), 55.02 g of MPEG350MA (MPEG350 methacrylate) and 19.06 g of i-BMA was metered in over a 5 h period using a peristaltic pump. On completion of the metered addition, 0.40 g of BP-50-FT was added for the further reaction and the mixture was stirred for a further 2 h. The mixture was cooled to room temperature and left overnight in the flask without stirring. The oil bath was heated again to 130° C., 0.40 g of BP-50-FT was added once more and the mixture stirred for 3 h.

The mixture was concentrated on a rotary evaporator and the solvent mixture completely removed. 150 g of the solvent-free polymer were dissolved in 150 g of n-butyl acetate.

GPC to DIN 55672-1:2016-03 (eluent: THF; standard: PMMA): Mw=14 900 g/mol; Mn=8610 g/mol; PDI=1.7.

### Copolymer I:

An initial charge of 29.9 g of n-butyl acetate in a 500 ml four-neck flask equipped with reflux condenser and N₂ line, dropping funnel, precision glass stirrer (200 rpm) and Pt100 digital internal thermometer was heated to 145° C. using an oil bath. A mixture of 9.8 g of APO (tert-amyl peroxy-2-ethylhexanoate), 56.0 g of i-BMA, 67.1 g of MPEG500MA and 2.2 g of 2-mercaptoethanol was added dropwise over a period of 4 h. In this case, the mixture was initially added dropwise for 1.5 h at a drop rate of 1 drop per 4 seconds and then for a further 2.5 h at a drop rate of 1 drop per 2 seconds, and the mixture was stirred at this temperature for a further 30 min. The mixture was cooled to 80° C., and 0.14 g of APO dissolved in 10 g of n-butyl acetate was metered in for further reaction. A further 15 g of isobutyl acetate was added and the mixture was stirred for a further 30 min without heating.

GPC to DIN 55672-1:2016-03 (eluent: THF; standard: PMMA): Mw=8474 g/mol; Mn=2426 g/mol; PDI=3.5.

### Copolymer J:

An initial charge of 29.9 g of n-butyl acetate in a 500 ml four-neck flask equipped with reflux condenser and N₂ line, dropping funnel, precision glass stirrer (200 rpm) and Pt100 digital internal thermometer was heated to 145° C. using an oil bath. A mixture of 9.8 g of APO (tert-amyl peroxy-2-ethylhexanoate), 56.0 g of i-BMA, 67.1 g of MPEG500MA and 2.2 g of 2-mercaptoethanol was continuously added dropwise over a period of 4 h at a drop rate of 1 drop per 2 seconds, and the mixture was stirred at this temperature for a further 30 min. The mixture was cooled to 80° C., and 0.14 g of APO dissolved in 10 g of n-butyl acetate was metered in for further reaction. A further 15 g of isobutyl acetate was added and the mixture was stirred for a further 30 min without heating.

GPC to DIN 55672-1:2016-03 (eluent: THF; standard: PMMA): Mw=6181 g/mol; Mn=2276 g/mol; PDI=2.7.

### Example 2: Production of the Phenolic Foam

For the performance comparison, the formulation in Table 2 was chosen.

TABLE 2
Formulation for production of phenolic foam

| Component | Parts by weight |
|---|---|
| Phenolic resin* | 100 |
| Foam stabilizer | 4.5 |
| Cyclo-/isopentane 85/15 | 10 |
| p-Toluenesulfonic acid 65% in water | 18 |

*Cellobond J6014L phenolic resin from Bakelite

The comparative foaming operations were carried out by manual mixing. For this purpose, phenolic resin (amount per batch: 180±5 g) and foam stabilizer were weighed into a beaker and mixed with a disc stirrer (diameter 6 cm) at 20° C. and 500 rpm for 30 s. Then the blowing agent was added and the mixture was mixed at 1500 rpm for 30 s and then cooled to 18° C. Then the acid was added and the mixture was stirred at 2000 rpm for 45 s and transferred to a 25 cm×25 cm×7 cm aluminium mould lined with polyethylene film and thermostatted to 60° C. After 1 h, the foams were demoulded and hardened in an oven heated to 60° C. for 18 h.

The pore structure was assessed subjectively on a scale from 1 to 10, where 10 represents an (idealized) impeccable, very fine foam and 1 represents a very significantly defective, coarse foam. The thermal conductivity coefficient (λ value in mW/m·K) was measured on 2.5 cm-thick discs with an instrument of the Hesto Lambda Control type, model HLC X206, at an average temperature of 10° C. in accordance with the specifications of standard EN12667:2001. For determination of the ageing of thermal conductivity, the test specimens were stored at 70° C. for 7 days and then analysed again. Density was determined according to ASTM D1622-2020.

The foam stabilizers according to the invention were examined analogously to the use of the polyether-modified siloxanes as individual components, and also in combination with an alkoxylated castor oil. For the comparative examples, TEGOSTAB® B 84905 from Evonik Operations GmbH was used as polyether-modified siloxane suitable for phenolic foam, and TAGAT® CH 40 as ethoxylated castor oil from Evonik Operations GmbH.

The results are presented in Tables 3 and 4.

TABLE 3
Properties of the phenolic foams

| | | Initial | λ after | Cell | Cell structure |
|---|---|---|---|---|---|
| | Density | λ in | ageing in | structure | (internal |
| Foam stabilizer | in kg/m³ | mW/mK | mW/mK | (surface) | defects) |
| TAGAT ® CH 40 | 36.2 | 23.3 | 26.9 | 6.0 | 6.5 |
| TEGOSTAB ® | 35.8 | 22.5 | 26.4 | 7.5 | 7.0 |
| B 84905 | | | | | |
| Copolymer A | 35.6 | 22.1 | 25.3 | 7.0 | 7.0 |
| Copolymer B | 35.2 | 22.6 | 25.8 | 7.5 | 6.5 |
| Copolymer C | 36.7 | 22.8 | 26.0 | 7.0 | 7.5 |
| Copolymer D | 36.1 | 21.9 | 25.0 | 7.5 | 7.5 |
| Copolymer E | 36.9 | 23.0 | 26.3 | 6.5 | 6.5 |
| Copolymer F | 35.8 | 22.4 | 25.8 | 8.0 | 7.0 |
| Copolymer G | 37.8 | 23.8 | 27.1 | 5.5 | 6.5 |
| Copolymer H | 36.9 | 23.5 | 27.0 | 6.0 | 6.0 |
| Copolymer I | 34.9 | 22.1 | 25.4 | 7.0 | 7.0 |
| Copolymer J | 35.7 | 22.3 | 25.5 | 7.5 | 7.0 |

The results show that it is possible with copolymers A-F and I and J to achieve foam qualities that are at the same level at or slightly above that of polyether-modified siloxanes. Copolymers G and H, compared to polyether-modified siloxanes, show slightly poorer foam qualities. However, these are still at the level of conventional alkoxylated vegetable oils and hence likewise enable the production of usable foams without polyether-modified siloxanes. All other use-relevant foam properties are affected only negligibly, if at all, by the copolymers according to the invention.

TABLE 4
Properties of the phenolic foams

| | | Initial | λ after | Cell | Cell structure |
|---|---|---|---|---|---|
| | Density | λ in | ageing in | structure | (internal |
| Foam stabilizer | in kg/m³ | mW/mK | mW/mK | (surface) | defects) |
| TAGAT ® CH 40/ | 35.2 | 22.1 | 25.5 | 7.0 | 7.5 |
| TEGOSTAB ® B | | | | | |
| 84905 (3.5:1.0) | | | | | |
| Copolymer A/ | 34.6 | 21.8 | 25.0 | 7.5 | 7.5 |
| TAGAT ® CH 40 | | | | | |
| (2.5:2.0) | | | | | |
| Copolymer B/ | 35.0 | 22.4 | 25.4 | 7.0 | 7.0 |
| TAGAT ® CH 40 | | | | | |
| (2.5:2.0) | | | | | |
| Copolymer C/ | 35.0 | 22.1 | 25.8 | 6.5 | 7.0 |
| TAGAT ® CH 40 | | | | | |
| (2.5:2.0) | | | | | |
| Copolymer D/ | 36.1 | 22.0 | 24.8 | 7.5 | 7.5 |
| TAGAT ® CH 40 | | | | | |
| (2.5:2.0) | | | | | |
| Copolymer E/ | 36.4 | 22.4 | 25.7 | 7.5 | 7.0 |
| TAGAT ® CH 40 | | | | | |
| (2.5:2.0) | | | | | |
| Copolymer F/ | 35.4 | 21.8 | 24.6 | 7.5 | 7.5 |
| TAGAT ® CH 40 | | | | | |
| (2.5:2.0) | | | | | |
| Copolymer G/ | 36.7 | 22.7 | 26.0 | 6.5 | 7.0 |
| TAGAT ® CH 40 | | | | | |
| (2.5:2.0) | | | | | |
| Copolymer H/ | 37.0 | 22.7 | 26.7 | 6.5 | 7.5 |
| TAGAT ® CH 40 | | | | | |
| (2.5:2.0) | | | | | |
| Copolymer I/ | 35.2 | 22.0 | 25.3 | 7.5 | 7.5 |
| TAGAT ® CH 40 | | | | | |
| (2.5:2.0) | | | | | |
| Copolymer J/ | 35.5 | 22.3 | 25.2 | 7.5 | 7.5 |
| TAGAT ® CH 40 | | | | | |
| (2.5:2.0) | | | | | |

The results show that it is possible with all copolymers in combination with ethoxylated castor oil to achieve foam qualities that are at the same level at or slightly above that of polyether-modified siloxanes in combination with ethoxylated castor oil. All other use-relevant foam properties are affected only negligibly, if at all, by the copolymers according to the invention.

1-16. (canceled)

17. A composition for producing phenolic foam, comprising at least one phenolic resin, at least one blowing agent, and at least one catalyst, wherein said composition further comprises at least one acrylate and/or methacrylate copolymer as a foam stabilizer.

18. The composition of claim 17, wherein the at least one acrylate and/or methacrylate copolymer comprises at least one comonomer of formula H₂C═CR¹—COOR² and at least one comonomer of formula H₂C═CR¹—COOR³, wherein:
R¹=each independently —H or —CH₃, wherein different comonomers having different R¹ substituents may be present within one copolymer;
R²=each independently identical or different radicals comprising saturated or unsaturated linear, cyclic or branched, aliphatic or aromatic hydrocarbons having 1 to 25 carbon atoms;
R³=each independently identical or different polyether radicals of average composition of formula (1): 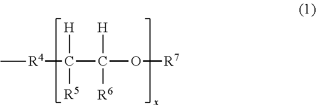
wherein:
x=1 to 500;
R⁴=each independently identical or different —CH₂—O—, —CH₂—CH₂—O—, —CH₂—CH₂—CH₂—O—, —CH₂—CH₂—CH₂—CH₂—O— or —CH₂—CH₂—CH₂—CH₂—CH₂—O— radicals, and wherein R⁴ may also be absent;
R⁵=each independently identical or different alkyl radicals having 1 to 18 carbon atoms and optionally having ether functions, or identical or different aryl radicals having 6 to 18 carbon atoms and optionally having ether functions, or H, methyl, ethyl or benzyl, wherein different R⁵ substituents within an R³ radical may be present in any order or sequence;
R⁶=each independently identical or different alkyl radicals having 1 to 18 carbon atoms and optionally having ether functions, or identical or different aryl radicals having 6 to 18 carbon atoms and optionally having ether functions, or H, methyl, ethyl or benzyl, wherein different R⁶ substituents within an R³ radical may be present in any order or sequence;
wherein, for one repeat monomer unit, both R⁵ and R⁶ radicals=H or one of the two R⁵ and R⁶ radicals=H and the other is methyl;
R⁷=each independently identical or different radicals selected from the group consisting of: R⁸, C(O)R⁸, —CH₂—CH(OH)—CH₂OH and —CH₂—C(CH₂OH)₂—CH₂—CH₃, where, within a copolymer, different comonomers may be present with different R⁷ substituents;
R⁸=each independently identical or different alkyl radicals having 1 to 16 carbon atoms, identical or different aryl radicals having 6 to 16 carbon atoms, or H.

19. The composition of claim 18, wherein:
R²=methyl, ethyl, n-butyl, isobutyl, t-butyl, 2-ethylhexyl, isodecyl, cyclohexyl, benzyl, phenyl, isobornyl or allyl;
R³=is a polyether radical of formula (1) wherein:
x=3 to 80; and
R⁷=methyl, butyl, H or C(O)Me.

20. The composition of claim 17, wherein the at least one blowing agent is selected from the group consisting of: hydrocarbons having 3, 4 or 5 carbon atoms; and halogenated hydrocarbons having 3, 4 or 5 carbon atoms.

21. The composition of claim 20, wherein at least one blowing agent is selected from the group consisting of: cyclo-, iso- and/or n-pentane; isopropyl chloride; 1234ze, 1234yf, 1224yd, 1233zd(E) and 1336mzz.

22. The composition of claim 17, wherein the at least one acrylate and/or methacrylate copolymer has a number-average molecular weight Mn, determined by gel permeation chromatography in accordance with DIN 55672-1:2016-03 (eluent: THF; standard: PMMA), in the range from 500 to 100 000 g/mol.

23. The composition of claim 22, wherein the at least one acrylate and/or methacrylate copolymer has a number-average molecular weight Mn, of 1000 to 25 000 g/mol.

24. The composition of claim 17, wherein the at least one acrylate and/or methacrylate copolymer is present in a total amount of 0.1 to 15 parts by weight based on 100 parts by weight of the total phenolic resin.

25. The composition of claim 17, wherein at least one Si-containing foam stabilizer is present.

26. The composition of claim 25, wherein the at least one Si-containing foam stabilizer is present in a total amount of less than 10% by weight based on the total amount of all foam stabilizers present.

27. The composition of claim 17, wherein the composition further comprises at least one silicon-free surfactant and/or silicon-free foam stabilizer, neither of which is an acrylate or methacrylate copolymer, in a total amount of 0.1 to 15 parts by weight based on 100 parts by weight of the total phenolic resin.

28. The composition of claim 17, wherein the composition further comprises at least one alkoxylated vegetable oil, in a total amount of 0.1 to 15 parts by weight based on 100 parts by weight of the total phenolic resin.

29. The composition of claim 17, wherein the composition further comprises castor oil in a total amount of 1 to 10 parts by weight, based on 100 parts by weight of the total phenolic resin.

30. The composition of claim 17, wherein the at least one catalyst is selected from the group consisting of organic and inorganic acids.

31. The composition of claim 30, wherein the at least one catalyst is selected from the group consisting of: sulfuric acid, phosphoric acid, benzenesulfonic acid, xylenesulfonic acid, para-toluenesulfonic acid, ethylbenzenesulfonic acid, naphtholsulfonic acid, cumenesulfonic acid and phenolsulfonic acid.

32. The composition of claim 17, wherein the at least one catalyst is present in a total amount of 1 to 30 parts by weight based on 100 parts by weight of the total phenolic resin.

33. The composition of claim 32, wherein the at least one catalyst is present in a total amount of 3 to 20 parts by weight based on 100 parts by weight of the total phenolic resin.

34. The composition of claim 17, wherein the residual monomer content is <1% by weight based on the total acrylate and/or methacrylate copolymer present.

35. A process for producing phenolic foam, comprising a reaction mixture with a composition as defined in claim 17.

36. A phenolic foam produced by the process of claim 36.
